(19) United States
(12) Patent Application Publication
(10) Pub. No.: US 2026/0219710 A1
(43) Pub. Date: Jul. 30, 2026

(54) COMPUTING AND STORAGE SYSTEM

(71) Applicant: Ximena Mejia Sanchez, Midland, TX (US)

(72) Inventor: Ximena Mejia Sanchez, Midland, TX (US)

(21) Appl. No.: 19/041,615

(22) Filed: Jan. 30, 2025

(51) Int. Cl. G06F 1/16

(52) U.S. Cl. CPC G06F 1/1656; G06F 1/1635

(57) ABSTRACT

A computing and storage system for performing computing operations and storing devices compactly includes a laptop computer which includes a phone slot for holding a phone and a phone connector in the slot which operatively couples a phone processor of the phone to a computer processor of the laptop computer when the phone connector is plugged into the phone. So connected, the phone processor may be used to perform operations on data stored on a computer memory of the laptop computer in conjunction with the computer processor. The computer processor may also control the phone processor to operate electronics in the phone. For example, the computer may be operated to make a phone call using the phone. Other devices such as earbud cases may be stored in other slots of the laptop computer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to computing systems and more particularly pertains to a new computing system for performing computing operations and storing devices compactly.

### (2) Description of Related Art including information disclosed under 37 CFR 1.97 and 1.98.

The prior art relates to computing systems, including those in which a phone may be connected physically and operatively to a computer while being stored within a housing of the computer to make for compact storage and facilitate use of processors in both devices simultaneously. The prior art fails to describe such a device which includes such features in addition to various display modules, solar charging components, and additional storage for other components.

### BRIEF SUMMARY OF THE INVENTION

An embodiment of the disclosure meets the needs presented above by generally comprising a laptop computer which includes a base panel that houses a plurality of computing components of the laptop computer. The plurality of computing components includes a computer processor and a computer memory. The base panel has a top wall, a bottom wall, and a perimeter wall extending between the top wall and the bottom wall. The base panel also defines a phone slot which extends into the perimeter wall. The laptop computer includes a phone connector which is mounted on a recessed wall of the phone slot. A phone, such as a smartphone, is insertable into the phone slot such that the phone connector plugs into the phone. The phone comprises a phone processor which operatively couples to the computer processor via the phone connector when the phone connector is plugged into the phone. The phone processor is configured to perform operations on data in the computer memory when the phone processor is operatively coupled to the phone.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a computing and storage system according to an embodiment of the disclosure.

FIG. 2 is a first side view of a laptop computer of an embodiment of the disclosure.

FIG. 3 is a back view of a laptop computer of an embodiment of the disclosure.

FIG. 4 is a bottom view of a laptop computer of an embodiment of the disclosure.

FIG. 5 is a second side view of a laptop computer of an embodiment of the disclosure.

FIG. 6 is a front view of a laptop computer of an embodiment of the disclosure.

FIG. 7 is a detail perspective view of a phone and a laptop computer of an embodiment of the disclosure.

FIG. 8 is a block diagram of a laptop computer of an embodiment of the disclosure.

### DETAILED DESCRIPTION OF THE INVENTION

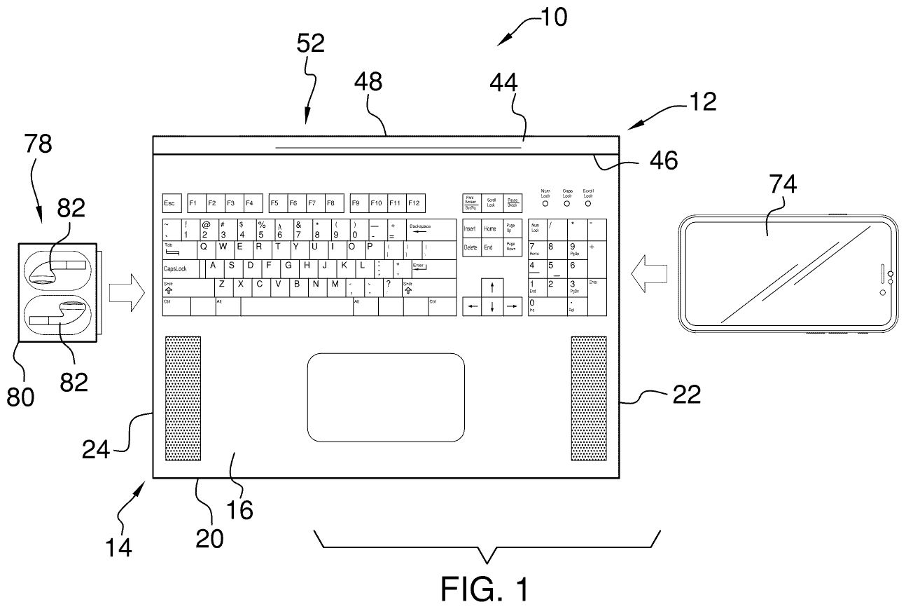

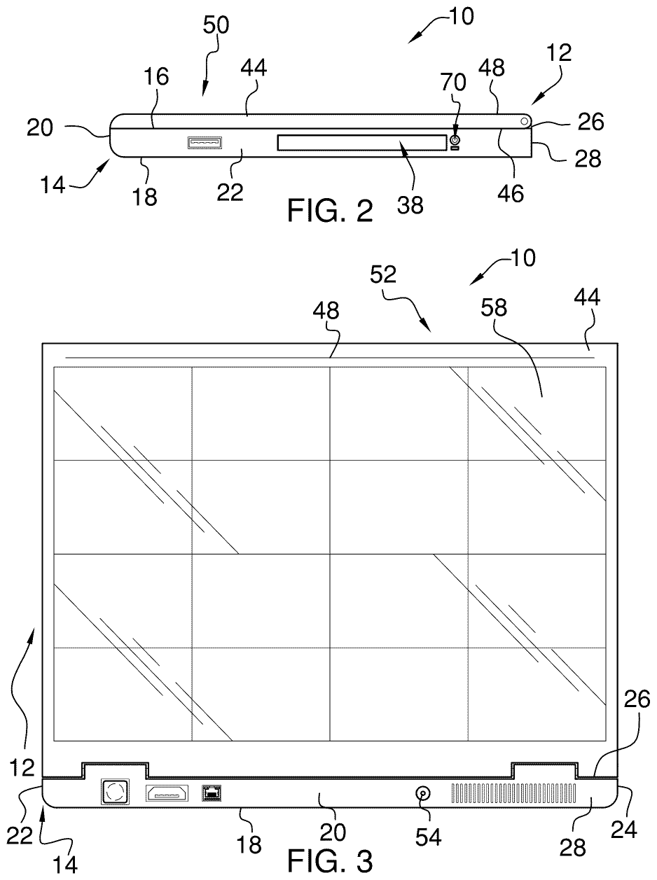

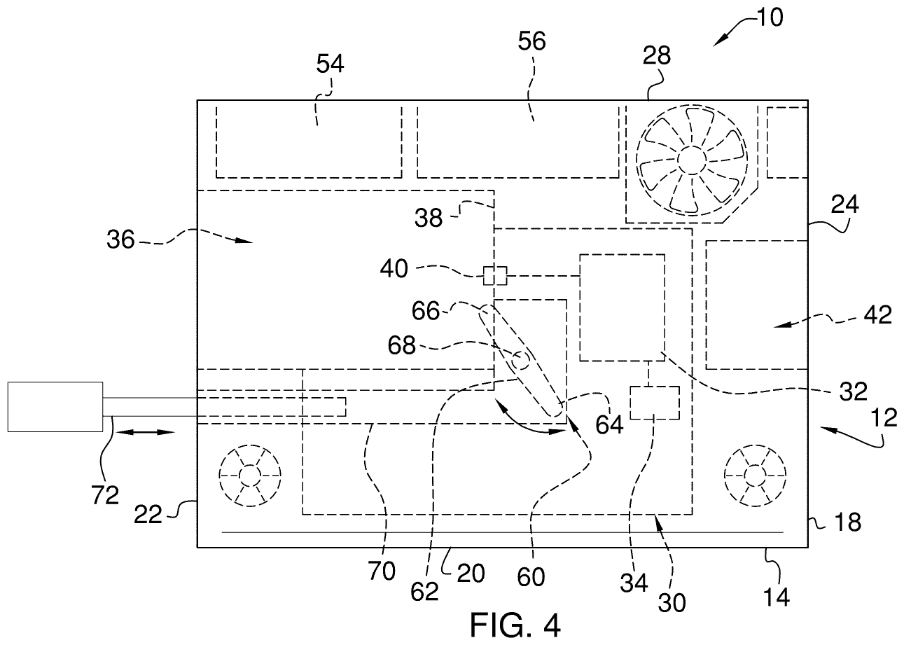

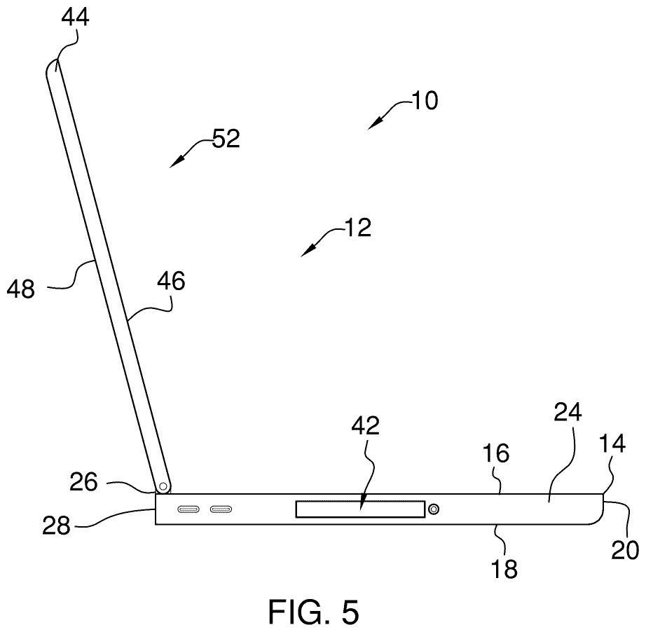

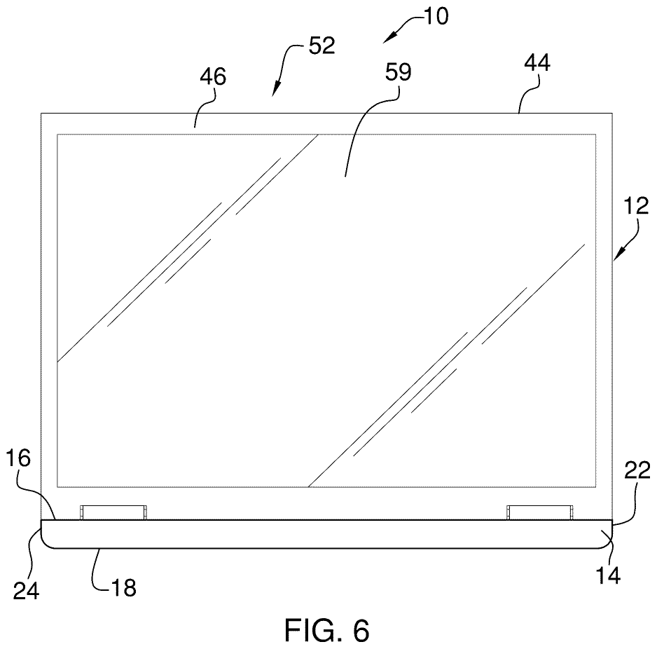

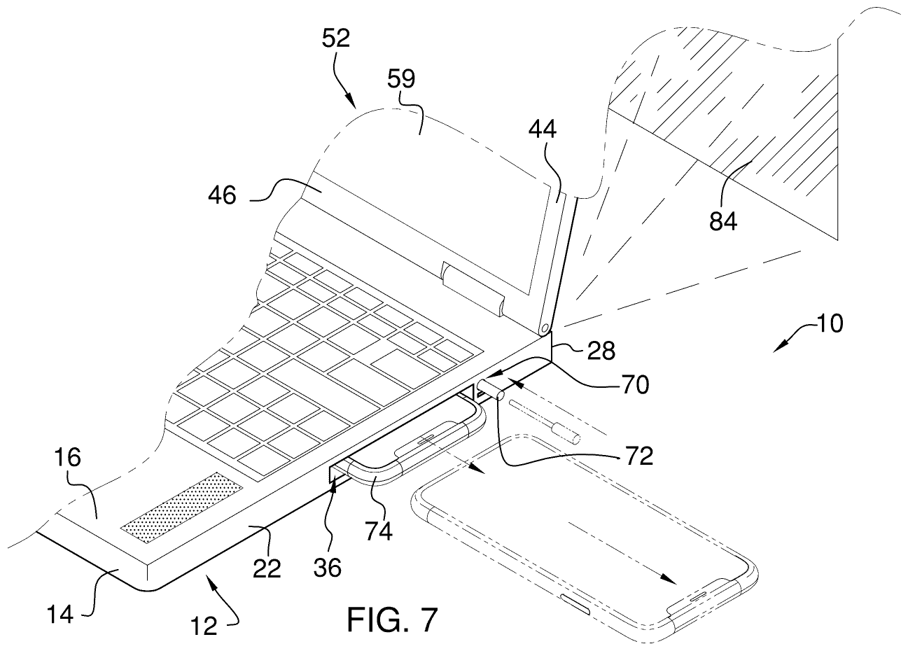

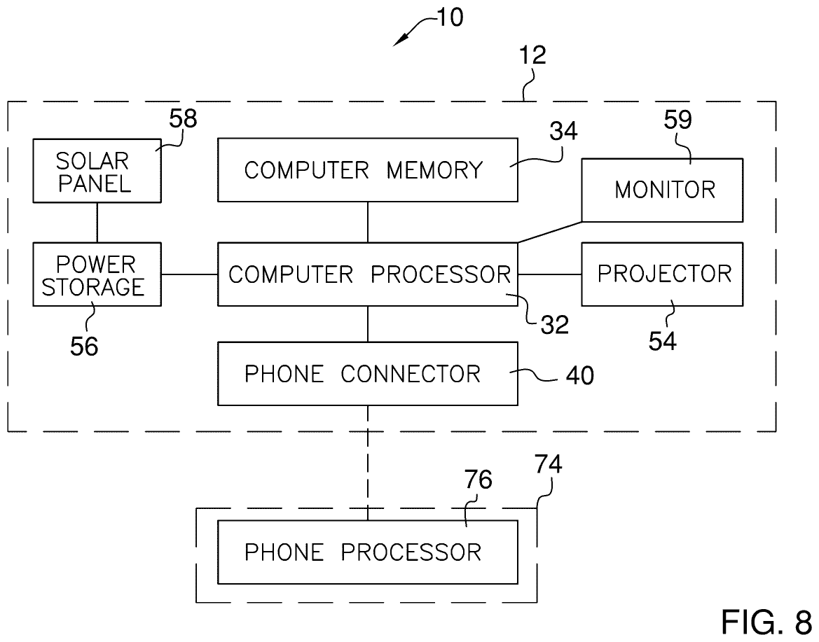

With reference now to the drawings, and in particular to FIGS. 1 through 8 thereof, a new computing system embodying the principles and concepts of an embodiment of the disclosure and generally designated by the reference numeral 10 will be described.

As best illustrated in FIGS. 1 through 8, the computing and storage system 10 generally comprises a laptop computer 12 which includes a base panel 14 with a top wall 16, a bottom wall 18, and a perimeter wall 20 extending between the top wall 16 and the bottom wall 18. The base panel 14 defines a phone slot 36 which extends into the perimeter wall 20 and is open on a perimeter wall 22 of the base panel 14. The base panel 14 also defines an earbud case slot 42 which extends into the perimeter wall 20 and is open on a second lateral side 24 of the base panel 14. The laptop computer 12 also comprises a plurality of computing components 30 housed in the base panel 14, including a computer processor 32 and a computer memory 34. The laptop computer 12 includes a phone connector 40 which is mounted on a recessed wall 38 of the phone slot 36.

The laptop computer 12 has a top panel 44 which is pivotably mounted to the base panel 14 at a top rear edge 26 of the base panel 14. The top panel 44 has a front side 46 and a back side 48. The top panel 44 is positionable in a closed position 50 in which the top panel 44 lies over the base panel 14 with the front side 46 facing the base panel 14. The top panel 44 is also positionable in an open position 52 in which the top panel 44 extends upwardly from the base panel 14 with the front side 46 facing forwardly with respect to the base panel 14.

The laptop computer 12 includes a projector 54 mounted in the base panel 14 at a rear end 28 of the base panel 14 which is operatively coupled to the computer processor 32. The projector 54 is configured to project images rearwardly with respect to the base panel 14. A power storage 56 module is mounted in the base panel 14. The power storage 56 module comprises a battery but may comprise a capacitor or other suitable power storage 56 means. A solar panel 58 is mounted on the rear side of the top panel 44 and is electrically coupled to the power storage 56 to charge the power storage 56.

The laptop computer 12 also includes an ejection mechanism 60 which is mounted in the base panel 14 for ejecting items from the phone slot 36. The ejection mechanism 60 comprises a lever 62 pivotably mounted in the base panel 14 adjacent to the phone slot 36. The lever 62 is pivotable about a pivot point 68 positioned between an input end 64 and an output end 66. The lever 62 is pivotable to move the output end 66 into the phone slot 36 toward an opening of the phone slot 36. The ejection mechanism 60 further comprises a conduit 70 positioned adjacent to the phone slot 36, the conduit 70 extends between the perimeter wall 20 and the lever 62 adjacent to the input end 64. The conduit 70 is configured for receiving an actuator pin 72 to facilitate urging the actuator pin 72 against the lever 62 adjacent to the input end 64.

A phone 74 is provided which is insertable into the phone slot 36 such that the phone connector 40 plugs into the phone 74. The phone 74 comprises a phone processor 76, and the phone connector 40 operatively couples the phone processor 76 to the computer processor 32 when the phone connector 40 is plugged into the phone 74. The phone processor 76 is configured to perform operations on data in the computer memory 34 when the phone processor 76 is operatively coupled to the phone 74. The computer processor 32 is configured to control the phone processor 76 such as to cause the phone processor 76 to make phone calls, access apps installed on the phone 74, and the like.

An earbud module 78 is provided which comprises an earbud case 80 and a pair of earbuds 82. The earbud case 80 houses the pair of earbuds 82 and is insertable into the earbud case slot 42 of the laptop computer 12 for storage therein. In some embodiments, another connector may be positioned in the earbud case slot 42 of the laptop computer 12 which electrically couples the earbud case 80 to the power storage 56 module of the laptop computer 12 to electrically charge another battery or batteries installed in the earbud case 80 or in each earbud 82.

In use, the phone 74 and the earbud case 80 are storable in the phone slot 36 and the earbud case slot 42 as described above. The computer processor 32 may control the phone processor 76 when the phone connector 40 is plugged into the phone 74 such that the phone processor 76 may take on processing tasks which the computer processor 32 would otherwise bear on its own when the phone processor 76 is disconnected. The computer processor 32 may also be used to access apps and other files on the phone 74 when the phone connector 40 is plugged into the phone 74. The projector 54 is operable to project a display of the laptop computer 12 on a projection surface 84 positioned rearwardly of the base panel 14. The laptop computer 12 may also have a monitor 59 positioned on the front side 46 of the top panel 44 of the laptop computer 12 for presenting another display for the laptop computer 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A computing and storage system comprising:
a laptop computer comprising:
a base panel, the base panel having a top wall, a bottom wall, and a perimeter wall extending between the top wall and the bottom wall, the base panel defining a phone slot which extends into the perimeter wall;
a plurality of computing components housed in the base panel, the plurality of computing components including a computer processor and a computer memory; and
a phone connector mounted in the phone slot, the phone connector being positioned on a recessed wall of the phone slot; and
a phone which is insertable into the phone slot such that the phone connector plugs into the phone, the phone comprising a phone processor, the phone connector operatively coupling the phone processor to the computer processor when the phone connector is plugged into the phone, the phone processor being configured to perform operations on data in the computer memory when the phone processor is operatively coupled to the phone.

2. The computing and storage system of claim 1, wherein:
the base panel of the laptop computer defines an earbud case slot which extends into the perimeter wall; and
further comprising an earbud module comprising an earbud case and a pair of earbuds, the earbud case being insertable into the earbud case slot of the laptop computer, the earbud case housing the pair of earbuds.

3. The computing and storage system of claim 1, wherein the laptop computer further comprises a top panel pivotably mounted to the base panel, the top panel being positioned at a top rear edge of the base panel, the top panel having a front side and a back side, the top panel being positionable in a closed position in which the top panel lies over the base panel with the front side facing the base panel, the top panel being positionable in an open position in which the top panel extends upwardly from the base panel with the front side facing forwardly with respect to the base panel.

4. The computing and storage system of claim 1, wherein the laptop computer further comprises a projector mounted in the base panel at a rear end of the base panel, the projector being operatively coupled to the computer processor, the projector being configured to project images rearwardly with respect to the base panel.

5. The computing and storage system of claim 1, wherein the laptop computer further comprises a power storage module mounted in the base panel and operatively coupled to the processor.

6. The computing and storage system of claim 5, wherein the power storage module comprises a battery.

7. The computing and storage system of claim 1, wherein the laptop computer further comprises an ejection mechanism mounted in the base panel for ejecting items from the phone slot, the ejection mechanism comprising a lever pivotably mounted in the base panel adjacent to the phone slot, the lever being pivotable about a pivot point positioned between an input end and an output end, the lever being pivotable to move the output end into the phone slot toward an opening of the phone slot, the ejection mechanism further comprising a conduit positioned adjacent to the phone slot, the conduit extending between the perimeter wall and the lever adjacent to the input end, the conduit being configured for receiving an actuator pin to facilitate urging the actuator pin against the lever adjacent to the input end.

8. The computing and storage system of claim 1, wherein the laptop processor is. configured to control the phone processor.

9. A computing and storage system comprising:
a laptop computer comprising:
a base panel, the base panel having a top wall, a bottom wall, and a perimeter wall extending between the top wall and the bottom wall, the base panel defining a phone slot which extends into the perimeter wall, the phone slot being open on a first lateral side of the base panel, the base panel defining an earbud case slot which extends into the perimeter wall, the earbud case slot being open on a second lateral side of the base panel;
a plurality of computing components housed in the base panel, the plurality of computing components including a computer processor and a computer memory;
a phone connector mounted in the phone slot, the phone connector being positioned on a recessed wall of the phone slot;
a top panel pivotably mounted to the base panel, the top panel being positioned at a top rear edge of the base panel, the top panel having a front side and a back side, the top panel being positionable in a closed position in which the top panel lies over the base panel with the front side facing the base panel, the top panel being positionable in an open position in which the top panel extends upwardly from the base panel with the front side facing forwardly with respect to the base panel;
a projector mounted in the base panel at a rear end of the base panel, the projector being operatively coupled to the computer processor, the projector being configured to project images rearwardly with respect to the base panel;
a power storage module mounted in the base panel and operatively coupled to the processor, the power storage module comprising a battery;
a solar panel mounted to the top panel, the solar panel being positioned on the rear side of the top panel, the solar panel being electrically coupled to the power storage; and
an ejection mechanism mounted in the base panel for ejecting items from the phone slot, the ejection mechanism comprising a lever pivotably mounted in the base panel adjacent to the phone slot, the lever being pivotable about a pivot point positioned between an input end and an output end, the lever being pivotable to move the output end into the phone slot toward an opening of the phone slot, the ejection mechanism further comprising a conduit positioned adjacent to the phone slot, the conduit extending between the perimeter wall and the lever adjacent to the input end, the conduit being configured for receiving an actuator pin to facilitate urging the actuator pin against the lever adjacent to the input end;
a phone which is insertable into the phone slot such that the phone connector plugs into the phone, the phone comprising a phone processor, the phone connector operatively coupling the phone processor to the computer processor when the phone connector is plugged into the phone, the phone processor being configured to perform operations on data in the computer memory when the phone processor is operatively coupled to the phone, the laptop processor being configured to control the phone processor; and
an earbud module comprising an earbud case and a pair of earbuds, the earbud case being insertable into the earbud case slot of the laptop computer, the earbud case housing the pair of earbuds.
